(19) United States
(12) Patent Application Publication
(10) Pub. No.: US 2026/0106226 A1
(43) Pub. Date: Apr. 16, 2026

(54) METHOD FOR PRODUCING A MATERIAL OR A COMPONENT FOR A SOLID-STATE BATTERY

(71) Applicant: Forschungszentrum Jülich GmbH, Jülich (DE)

(72) Inventors: Gerald Dück, Köln (DE); Martin Finsterbusch, Jülich (DE); Dina Fattakhova-Rohlfing, München (DE); Olivier Guillon, Jülich (DE)

(21) Appl. No.: 19/115,233

(22) PCT Filed: Aug. 18, 2023
(86) PCT No.: PCT/EP2023/072869

§ 371 Date: Mar. 25, 2025

(30) Foreign Application Priority Data
Sep. 26, 2022 (DE) 10 2022 210 150.2

(51) Int. Cl. H01M 10/058; H01M 4/04; H01M 4/58; H01M 10/054; H01M 10/0562; H01M 50/403; H01M 50/434; H01M 50/46

(52) U.S. Cl. CPC H01M 10/058; H01M 4/0471; H01M 4/5825; H01M 10/054; H01M 10/0562; H01M 50/403; H01M 50/434; H01M 50/46; H01M 2300/0071

(57) ABSTRACT

The invention relates to a method for producing a material for a solid-state battery and/or a component for a solid-state battery, as well as a solid-state battery cell. In the method for producing a material (10) for a solid-state battery (30) and/or a component (20) for a solid-state battery (30), at least one starting material (1) together with a sodium source (2) and H₃BO₃ is heated (5) to a temperature between 600° C. and 1300° C. The material and/or component can be produced at a significantly lower temperature.

The invention relates to a method for producing a material for a solid-state battery and/or a component for a solid-state battery and a solid-state battery cell.

Solid-state sodium batteries are considered to be promising energy storage devices, as they have advantages over conventional lithium batteries with organic liquid electrolyte in terms of cost, availability of materials and operational safety. However, producing such batteries is technically complex and cost-intensive.

The components of solid-state sodium batteries include the electrodes and the separator, which electrically isolates neighboring electrodes of different cells from each other and typically fulfills the function of the solid electrolyte. These components can be produced individually or in various combinations by sintering, wherein dense structures are typically produced. In the case of commercially available high-temperature Na batteries, the electrolyte is β″-alumina. Compounds known as NaSICON, which is an acronym for “Na Super lonic Conductor”, are suitable for low-temperature systems, for example materials of the NZSP family (Na₁₊ₓZr₂SiₓP₃₋ₓO₁₂). These inorganic compounds can be present as glasses or crystallize in rhombohedral or monoclinic structures and exhibit very good ionic conductivity combined with very low electrical conductivity. Examples are described in the publications U.S. Pat. No. 10,020,508 B2, EP2 900 594 B1, KR 101 974 848 B1, KR 102 339 641 B1, JP 5 753 852 B2 and U.S. Pat. No. 8,012,633 B2. These materials are usually produced by multiple calcination, typically at 900° C. to 1200° C., and subsequent sintering at temperatures between 1200° C. and 1300° C. to produce the dense ceramic for the desired component. Grinding steps are often carried out in between. Overall, this leads to a large technical effort, high energy consumption and high costs.

The above-mentioned characteristics and properties can be combined with the claimed objects as desired, unless otherwise specified.

The publication “Liquid-phase sintering of highly Na⁺ ion conducting Na₃Zr₂Si₂PO₁₂ ceramics using Na₃BO₃ additive” by Noi et al. (DOI: 10.1111/jace.15288) describes the use of sodium borate to reduce the sintering temperature when producing a battery component with a NaSICON compound. The additive is sintered together with a previously produced NaSICON powder to produce the component. The additive used is produced beforehand using two calcination steps and with intermediate grinding and must also be handled in a protective gas atmosphere.

It is the task of the invention to provide an improved method for producing a material and/or a component for a solid-state battery as well as an improved solid-state battery cell.

The task is solved by the method according to claim 1 and by the solid-state battery cell according to the additional claim.

A method for producing a material for a solid-state battery and/or for producing a component for a solid-state battery, in which at least one starting material is heated together with a sodium source and H₃BO₃ to a temperature between 600° C. and 1300° C., serves to solve the problem.

On the one hand, the method can be used to produce a material for a solid-state battery, in particular a NaSICON material. The NaSICON crystal structure is produced by the heating. The produced material is suitable for producing a solid-state battery. On the other hand, the method can be used to produce at least one component for a solid-state battery. In this case, the component is sintered during heating and thus produced as a solid body of the desired shape. Combinations of both are possible.

In both cases, the sodium source and H₃BO₃ (together referred to as additives according to the invention) enable a method at a significantly reduced temperature. In this way, the technical effort as well as the energy required and thus the costs are reduced. The additives used can be processed in an air atmosphere and are therefore comparatively easy to handle. The time and energy-intensive production of Na₃BO₃ is not necessary. In the case of producing a NaSICON material, the required properties such as density, ionic conductivity and the NaSICON crystal structure are achieved even at the lower temperature.

In particular, the temperature between 600° C. and 1300° C. to which the material is heated is the maximum temperature. In other words, no heating to a higher temperature takes place during the producing of the material and/or component for a solid-state battery. Preferably, heating is carried out to at most 1200° C.

The solid-state battery is in particular a solid-state sodium battery. A sodium source is a substance including sodium. A substance within the meaning of the invention comprises a mixture of substances. In particular, a substance is meant that includes sodium that is chemically available in the course of the method. The sodium source is in particular an alkaline sodium compound, for example NaOH, Na₂CO₃ or NaHCO₃. Alkaline sodium compounds enable particularly far-reaching reductions in temperature.

In particular, the material produced according to the invention and/or the component produced according to the invention includes less than 20%, preferably less than 10% and particularly preferably less than 5% secondary phase. In other words, the vast majority of the material and/or the component, for example at least 80%, preferably at least 90% and in particular at least 95%, has the desired NaSICON crystal structure. In particular, the material and/or component produced according to the invention includes a boron concentration (g/g) of 0.2% to 0.8%, preferably 0.4% to 0.6% (before sintering). These are values that apply to the examples given below. Depending on the application, the optimum boron concentration can also shift upwards or downwards. As boron is volatile at high temperatures, the boron concentration may decrease at high sintering temperatures. After heating and/or sintering at 900° C., the boron concentration used (corresponding to the additive concentration used according to the invention) remains approximately the same. As the sintering temperature increases, the remaining measurable boron concentration decreases continuously and after sintering at 1260° C. the boron content is below the detection limit. Between these temperatures, a steady decrease in the boron concentration is to be expected. The boron concentration can be determined by ion beam analysis (IBA), wherein in particular the particle-induced gamma quantum emission (PIGE) of boron at 718 keV can be used for analysis. The density-corrected total emission can be evaluated and, in particular, compared with the respective parameters of the sample production. Materials and/or components produced according to the invention can thus be recognized by the comparatively high boron concentration.

In one embodiment, the temperature is below 1100° C., in particular below 1000° C. and preferably below 900° C. In one configuration, the temperature is approx. 850° C. It is possible to lower the temperature to 850° C. and possibly even lower, especially when producing components for a solid-state battery from intermediate products, e.g., from calcined educts for the production of NaSICON. Tests have shown that relevant properties of the produced component such as ionic conductivity and relative density as well as the NaSICON crystal structure are good in this case despite the significantly reduced sintering temperature. To achieve the desired crystal structure with conventional methods, at least one calcination step above 1000° C. is necessary. The same temperatures are possible when producing the NaSICON material for a solid-state battery. Similar to what is described above, the respective temperature to which the material is heated is, in particular, the maximum temperature.

In principle, a very low temperature enables great savings in terms of effort and costs, but leads to a deterioration in the properties of the material or component produced, at least from a certain point onwards. The optimum temperature therefore depends on the respective requirements. Depending on the application, a temperature below 1100° C., 1050° C., 1000° C., 950° C., 900° C. or a temperature of approx. 850° C. or below 850° C. may therefore be optimum. The temperature reductions achieved by the invention are significantly greater than when using Na₃BO₃.

The temperature is preferably above 700° C., in particular above 800° C., in order to achieve sufficient crystallinity, ionic conductivity and/or density of the produced material or component.

In one embodiment, NaOH is used as the sodium source. It has been shown that NaOH enables particularly high temperature reductions among the alkaline sodium sources. In addition, NaOH has a high availability and is inexpensive.

In one configuration, a mixing ratio of NaOH and H₃BO₃ (orthoboric acid) is greater than 1 mol/mol, in particular greater than 2 mol/mol and/or less than 6 mol/mol, in particular less than 4 mol/mol. Preferably, the mixing ratio is approx. 3 mol/mol.

In particular, a mixing ratio of the additives according to the invention to NaSICON, to an educt for producing NaSICON and/or to an intermediate product for producing NaSICON is at least 0.02 g/g, in particular at least 0.04 g/g, preferably at least 0.06 g/g and/or at most 0.2 g/g, in particular at most 0.14 g/g, preferably at most 0.11 g/g. In one particularly preferred embodiment, the mixing ratio is approx. 0.05 g/g, approx. 0.071 g/g, approx. 0.107 g/g, at least 0.065 g/g and/or at most 0.08 g/g. This applies both to producing a material for a solid-state battery and to producing a component.

In one embodiment, a material for a solid-state battery which includes NaSICON is produced. In particular, the starting material includes educts for producing NaSICON. For example, the starting material includes a mixture of educts for producing NaSICON, e.g., a mixture of sodium nitrate, zirconium nitrate, tetraethyl orthosilicate, and ammonium dihydrogen phosphate for producing Na_{3.4}Zr₂Si_{2.4}P_{0.6}O₁₂ (NZSiP3.4). The mixture of educts for producing NaSICON is in particular such that NaSICON can be produced by sintering without the addition of further substances (complete mixture). Educts or precursors for producing NaSICON means substances which can be heated together in mixed form and in particular also pressed in order to produce NaSICON in this way. It may be advantageous to perform a heat treatment at least once before pressing at a temperature, for example between 750° C. and 800° C., in particular to burn out the nitrates, and typically to perform grinding afterwards. In particular, the mixture that is heated does not include any additives other than the sodium source and H₃BO₃.

In particular, a material for a solid-state battery which includes NaSICON, preferably consists of NaSICON, is produced. This is also referred to as synthesis. Sintering takes place during heating, so that the heating step is also referred to as sintering. During sintering, a NaSICON crystal structure is produced, which leads to the well-known high ionic conductivity.

Compared to conventional methods, the usual several calcination steps and grinding in between are no longer necessary. The temperature is also reduced.

NaSICON are substances with the formula M^{I}_{1+2w+x-y+z}M^{II}_{w}M^{III}ₓ(Zr, Hf)^{IV}_{2-w-x-y}M^{V}_{y}(SiO₄)_{z}(PO₄)_{3-z}. M^{I} is Na. M^{II}, M^{III} and M^{V} are suitable divalent, trivalent and pentavalent metal cations, respectively. For example, M^{II} can be Mg²⁺, Ca²⁺, Sr²⁺, Ba²⁺, Co²⁺ and/or Ni²⁺. For example, M^{III} can be Al³⁺, Ga³⁺, Sc³⁺, La³⁺, Y³⁺, Gd³⁺, Sm³⁺, Lu³⁺, Fe³⁺ and/or Cr³⁺. For example, M^{V} can be V⁵⁺, Nb⁵⁺ and/or Ta⁵⁺. Any combination is possible.

NaSICON may further comprise substances having the formula Na₁₊ₓZr₂SiₓP₃₋ₓO₁₂, 0<x<3. It may further comprise substances which are structurally composed according to the said formula and in which a proportion of Na, Zr and/or Si is replaced by isovalent and/or equivalent elements. NaSICON are solids. NaSICON have a high conductivity for sodium ions and a negligible electron conduction. Examples of NaSICON are also Na_{3.4}Zr_{2.0}(SiO₄)_{2.4}(PO₄)_{0.6} and Na₁₊ₓZr₂(SiO₄)ₓ(PO₄)₃₋ₓ (0≤x≤3), wherein the latter substance is also referred to as NZSP.

NaSICON can be produced, for example, by means of a solid-state reaction (SSR), by means of a sol-gel reaction such as solution-assisted SSR (SA-SSR) or by means of coprecipitation. In conventional methods, a calcination step above 1000° C. is necessary in any case, as otherwise the correct crystal structure of the NaSICON will not form. As described, this is no longer necessary due to the additives according to the invention.

Alternatively or additionally, the starting material may include intermediate products for producing NaSICON, which is described further below.

In a complementary or alternative embodiment, a component for a solid-state battery is produced. In this and other embodiments, the component is in particular a densely sintered component. The starting material may include at least one educt for producing NaSICON or a mixture of educts for producing NaSICON, for example as described above. The synthesis of the NaSICON and the sintering of the component can be carried out together in one step. This is also referred to as reactive sintering. For example, this is done to produce a separator.

In conventional methods, for example for producing the separator, NaSICON is produced by repeated calcination, brought into powder form, pressed into the desired shape of the component and then sintered at temperatures between 1200° C. and 1300° C. (in the case of NZSP, for example, 1260° C.). Until now, good ionic conductivity could only be achieved at such high temperatures. The invention allows a particularly complete mixture of educts for producing NaSICON together with the additives to be sintered once at a significantly reduced temperature in order to produce the NaSICON component with good ionic conductivity in a single step.

In an alternative or complementary embodiment, the starting material includes at least one intermediate product for producing NaSICON or a mixture of intermediate products for producing NaSICON. The starting material may include a mixture of calcined educts for producing NaSICON and/or a calcined mixture of educts for producing NaSICON. In particular, the intermediate product includes calcined powder.

In particular, an intermediate product for producing NaSICON (also referred to as a precursor) is a calcined educt for producing NaSICON, a mixture of calcined educts for producing NaSICON, or a calcined mixture of educts for producing NaSICON. An intermediate product may already have in parts a NaSICON crystal structure, but typically less than 20%, in particular less than 10%. In other words, the NaSICON crystal structure is produced by heating. In particular, the component includes a NaSICON portion which has a NaSICON crystal structure of more than 70%, in particular more than 90%, preferably more than 95% and in one configuration more than 98%.

In one configuration, a mixture of calcined powders or a calcined mixture of powders is used as the intermediate product for producing NaSICON. These are mixed with the additives according to the invention, for example in one of the ways described below. Typically, heating is then carried out. This can be done as a further calcination to produce the component. This is typically done in an oxygen-containing atmosphere.

In one configuration, the starting material includes a mixture of at least one educt for producing NaSICON and at least one intermediate product for producing NaSICON. In one configuration, a mixed electrode, for example a mixed cathode, is produced as a component, typically sintered. In particular, a mixed electrode includes phases of different materials, as described in detail below.

In one configuration, a starting material, preferably an intermediate product for producing NaSICON, is produced wet-chemically. Such a starting material can be fired in an additional step prior to heating, for example at a temperature between 700° C. and 850° C., typically at approx. 800° C. In this way, nitrates, for example, can be decomposed. Through firing, an intermediate product for producing NaSICON can be produced.

In an alternative or complementary embodiment, the starting material includes NaSICON itself. For example, the starting material may include completely crystalline NaSICON powder. Through the additives according to the invention, which here fulfill the function of a sintering aid, the temperature can be lowered as described without the need to generate Na₃BO₃.

Any mixtures of the above-mentioned ingredients of the starting material are possible. In other words, the component can be produced from educts for producing NaSICON, intermediate products and/or NaSICON itself. In particular, the starting material is such that NaSICON can be produced or obtained without the addition of further substances. In particular, the starting material in this embodiment does not include NaSICON. Already produced NaSICON material, for example in powder form, is used. In particular, the NaSICON material is already produced according to the invention. Here, too, a significantly lower temperature is required compared to conventional methods.

In particular, this embodiment is used to produce electrodes. Here, an active material and NaSICON, in particular in powder form, are heated together with the additives according to the invention.

In a further configuration, a component for a solid-state battery is produced, wherein the starting material includes a mixture of at least one intermediate product for producing NaSICON, at least one educt for producing NaSICON and/or NaSICON.

In one embodiment, the at least one starting material is provided in powder form. In one embodiment, the at least one starting material is mixed with the sodium source and the H₃BO₃, pressed into shape and/or heated. In particular, the heating takes place after mixing and/or pressing. In this embodiment, particularly favorable starting materials can be used. As starting material or starting materials, educts for producing NaSICON can be used, in particular in ground form. In other words, a solid-state reaction takes place.

Mixing with the sodium source and the H₃BO₃ can be carried out in such a way that a solution of the sodium source and the H₃BO₃ is produced. For example, an aqueous solution is produced. This can be mixed with the starting material. Alternatively or additionally, one or both of the additives according to the invention can also be added at least partially and in particular completely as a solid.

In one configuration, a solution, in particular an aqueous solution, of the additives according to the invention is produced. An intermediate product, in particular in powder form, can be added to the solution. The solvent can be removed, in particular by evaporation or vaporization. In this way, the intermediate product can be coated with the additives according to the invention. Due to the resulting uniform distribution of the additives according to the invention, production of a component can be carried out in a particularly advantageous manner.

The starting material or starting materials can be ground together with the sodium source and the H₃BO₃. Grinding can be dry or wet. The sodium source and/or the H₃BO₃ may be added in dry form or as a solution. Mixing can take place during grinding. This eliminates the need for an additional mixing step. The starting material or starting materials can be slurried with a solution of the additives according to the invention. The mixture of the additives according to the invention and the starting material or starting materials may be dried. This can take place before and/or after slurrying. Alternatively or additionally, the starting material or the starting materials can be wetted with a solution of the additives according to the invention.

In one configuration, the ground starting material is pressed into shape together with the additives according to the invention and sintered into a component by heating.

In one embodiment, a separator is produced as the component. The separator typically comprises NaSICON. In particular, the separator consists of NaSICON. A separator can, for example, have the shape of a film or a cup.

In one embodiment, an electrode, for example a cathode, is produced as the component. The electrode can be composed of different phases. In particular, the electrode comprises an ion-conducting phase comprising or consisting of NaSICON and an active material, also called active phase, for example of NNFM or NVP, as described further below. An electrode may also optionally have an electrically conductive phase. In particular with NaSICON and NNFM, there is the advantage that the lower temperature compared to the prior art reduces the occurrence of interfering secondary phases during sintering.

A separator and possibly also an electrode can be produced particularly advantageously in one step from at least one intermediate product and/or at least one educt for producing NaSICON.

In conventional methods, a NaSICON powder was applied to an already produced separator and then calcined and sintered. The invention enables direct production from educts for producing NaSICON, intermediate products for producing NaSICON and/or NaSICON, so that the number of process steps is reduced.

In one embodiment, the component comprises an electrode and a separator. In one embodiment, the electrode and the separator are heated together and in this way produced together in one step.

In other words, the separator and electrode, for example cathode, are produced in one step. The production can be carried out from NaSICON or educts for the production of NaSICON. Producing the electrode and the separator in one step means that the sintered shape of the electrode and the sintered shape of the separator are produced in a common heating process. In particular, no electrode is present before heating. In particular, no separator is present before heating. In particular, the electrode and separator are arranged directly adjacent to each other. In particular, there is a contact surface at which the separator and the electrode make contact over a large area. In particular, the separator and the electrode are firmly connected to each other at the contact surface. Preferably, the connection is produced by a sintering process, which is caused by the joint heating.

The separator is a component for the spatial and electrical separation of the electrodes but has ion-conducting properties. In conventional batteries, for example Li-ion batteries, the separator is a film soaked or impregnated with a liquid electrolyte. The separator according to the invention typically consists of an ion-conducting ceramic, i.e. the solid electrolyte. The electrode may be a cathode or, in particular in the case of a symmetrical solid-state battery, an anode. In particular, the electrode comprises an active material. In particular, the electrode comprises NVP (NaₓV₂P₃O₁₂) or preferably at least one layered oxide such as NNFM (Na_{0.67}[Fe_{0.1}Ni_{0.1}Mn_{0.8}]O₂), a sodium-manganese oxide with nickel and iron (Naₓ[Fe_{0.1}Ni_{0.1}Mn_{0.8}]O₂ or Na_{0.67}[Ni_{0.33}Mn_{0.67}]O₂ or with Co, as in Na[Ni_{0.33}Mn_{0.33}Co_{0.33}]O₂, NaₓCoO₂, (generally: NaₓMO₂ with M=Mn, Ni, Co, Fe, Mg or a mixture of 2 or 3 of the elements) or also oxides with a tunnel structure, such as Na_{0.61}[Fe_{0.34}Ti_{0.39}Mn_{0.27}]O₂. Just as the metal can be substituted in the oxide structures, the V can also be substituted in the NVP, e.g., with Al, Fe, Ti or similar. A general notation could be Na₃V₂₋ₓMₓ(PO₄)₃ with usually x between 0 and 1. Deviations are possible. The different phases of the electrode can be heated together due to the reduced temperature. This makes new material combinations possible.

In one configuration, a material is applied to a body or a material in particular before heating, so that joint heating is possible. For example, a starting material for producing the separator can be applied to a starting material for producing an electrode or vice versa. Alternatively, the starting material for producing the separator can be applied to a prefabricated electrode or an electrode precursor. Similarly, a starting material for producing the electrode can be applied to a prefabricated separator or a separator precursor. A precursor of a respective component is a component that has not yet been fully sintered, which can then be densely sintered and which preferably already has a certain dimensional stability. For example, a slurry can be applied. Application can be performed, for example, by film casting, vacuum slurry casting, roller coating or printing processes such as screen printing.

In conventional methods, the ceramic electrolyte and/or separator is first produced by sintering above 1200° C. The desired cathode active material is then applied to the finished electrolyte. By calcining again, additives such as solvents or organic binders are removed and good contact between the electrolyte and the active material is produced. Producing the electrolyte and electrode in one step is not yet possible for the vast majority of electrode active materials, as the necessary sintering of the electrolyte above 1200° C. would decompose the active material of the electrode or render it unusable by reacting with the electrolyte. This applies in particular to layered oxides, which have a higher capacity than NVP and are at the same time cheaper and less toxic.

In one configuration, the component produced is a half cell, i.e., a system comprising a separator and an electrode. In one configuration, the component produced is a full cell, i.e., a system comprising a separator and two electrodes, which are typically arranged on opposite sides of the separator. In particular, the full cell is a symmetrical cell, i.e., a cell in which the anode and cathode are identical, preferably including NVP or NNFM.

Each of the described components can be produced from NaSICON, at least one intermediate product for producing NaSICON and/or at least one educt for producing NaSICON. When producing an electrode and/or a component comprising a separator and an electrode, the use of at least one intermediate product for producing NaSICON and/or NaSICON is particularly advantageous for solving the problem.

In one embodiment, a component for a solid-state battery is produced. In particular, the component is a solid-state battery cell comprising or consisting of a separator and two electrodes. In particular, the electrodes are arranged on both sides of the separator and/or on opposite sides of the separator.

In one embodiment, the solid-state battery cell is a symmetrical solid-state battery cell with two electrodes. The electrodes may be of the same type. In particular, the electrodes have the same composition. In particular, the cathode and the anode are similarly structured. In particular, both electrodes comprise the same NaSICON material. In a further configuration, an anode comprises an anode active material and a cathode comprises a cathode active material, wherein the anode active material and the cathode active material are different and in particular each comprise different NaSICON compounds.

In one embodiment, the heating takes place in an oxygen-containing atmosphere. The atmosphere may be oxygen. In particular, however, an air atmosphere may be used. In other words, the heating is a calcination. This is done in particular for producing NaSICON-containing material for a solid-state battery and/or a component comprising at least one intermediate product and/or at least one educt for producing NaSICON. In addition to saving the series of work steps described above and reducing the temperature, this also eliminates the need for an inert gas atmosphere, e.g., an argon atmosphere. The technical effort is thus further reduced.

Producing a component comprising a separator and an electrode as described above can also be carried out in an oxygen-containing atmosphere. This is particularly possible when using NNFM as electrode active material, even when producing the component from at least one intermediate product and/or at least one educt for the production of NaSICON.

If a different electrode active material is used, for example NVP, this is also possible. However, if particularly high demands are made on the properties of the component, it is advantageous to produce NaSICON in a first step, preferably in an oxygen-containing atmosphere, and to produce the component comprising the NaSICON and the active material in a subsequent second step under an inert gas atmosphere, e.g. an argon atmosphere. This is similar when connecting the ion-conducting ceramic with the cathode active material.

A further aspect of the invention is a solid-state battery cell which can be produced or is produced according to the method of the invention. The solid-state battery cell comprises a separator and two electrodes. The electrodes can be of the same type and/or have the same composition. The electrodes may be produced from the same material or materials and/or have the same structure. In particular, the electrodes are mixed electrodes. In particular, the cell is constructed analogously to a rocking-chair battery cell (conventional lithium-ion battery cell). In particular, the active material is not or not completely sodiated. All features, embodiments and advantages of the aspect of the invention mentioned at the beginning apply analogously to this aspect and vice versa.

In one embodiment, at least one of the electrodes comprises NNFM, typically as an active material. In particular, at least one of the electrodes further includes NaSICON as an ion-conducting phase. In one embodiment, the separator comprises NaSICON. In particular, the separator is produced from NaSICON. Preferably, the separator is produced according to the invention.

In one embodiment, at least one of the electrodes, for example the cathode, in particular both electrodes, comprises NNFM and NaSICON. In other words, these are mixed electrodes such as a mixed cathode. In particular, the mixed electrode is produced using the method according to the invention. In one embodiment, one of the two electrodes is produced from sodium. Particles of NaSICON and the selected active material, e.g., NNFM, are present next to each other in a mixed electrode. Accordingly, to produce a mixed electrode, educts for producing NaSICON, intermediate products for producing NaSICON or crystalline NaSICON, in particular in powder form, can be mixed with the active material, preferably also as a powder, and heated. In other words, they are mixed and sintered together. The additives according to the invention are added to the educts, intermediate products or the NaSICON before heating. In particular, in this way, starting from respective powders, production can be carried out in a single sintering step.

A further aspect of the invention is a method for producing a material and/or a component for a solid-state battery, in which at least one starting material is heated to a temperature between 600° C. and 1300° C. together with a sodium source and an acid, in particular an inorganic acid. In addition to H₃BO₃, the acid used can be HNO₃, H₃PO₄, HCl, H₂SO₄ or H₂SO₃, for example. All features, embodiments and advantages of the aspect of the invention mentioned at the beginning apply analogously to this aspect.

All of the features, embodiments and configurations mentioned in this application can be combined with one another in any desired manner, unless otherwise indicated.

In the following, exemplary embodiments of the invention are also explained in more detail with reference to experiments and figures. Features of the exemplary embodiments may be combined individually or in a plurality with the claimed subject-matter, unless otherwise indicated. The claimed scopes of protection are not limited to the exemplary embodiments.

The Figures Show:

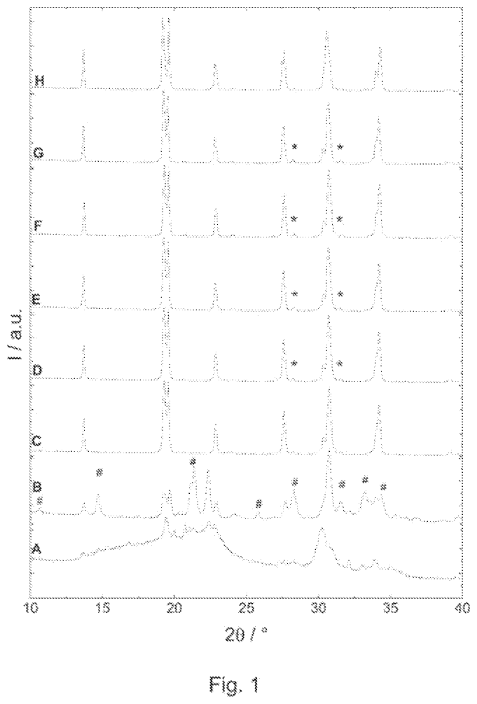

FIG. 1: X-ray diffractogram of various samples,

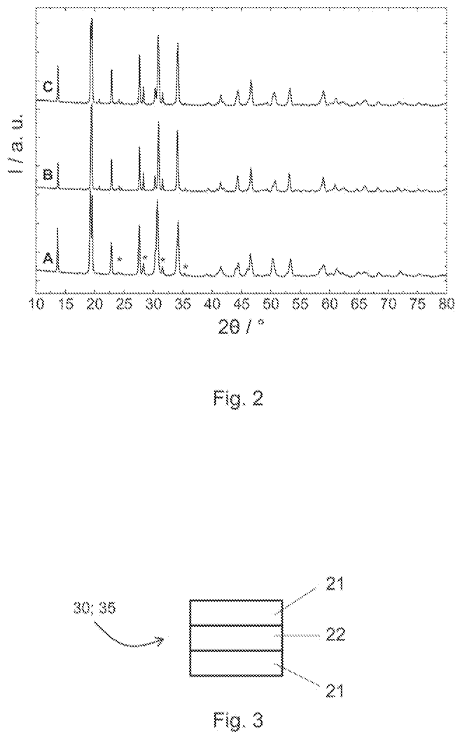

FIG. 2: further X-ray diffractogram of various samples,

FIG. 3: schematic representation of a solid-state battery cell.

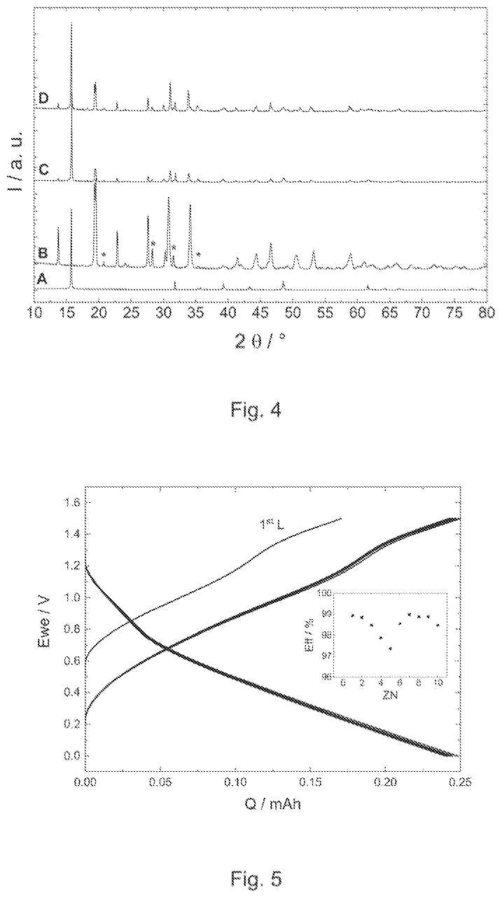

FIG. 4: X-ray diffractogram of various samples,

FIG. 5: charge-discharge curves of a battery cell,

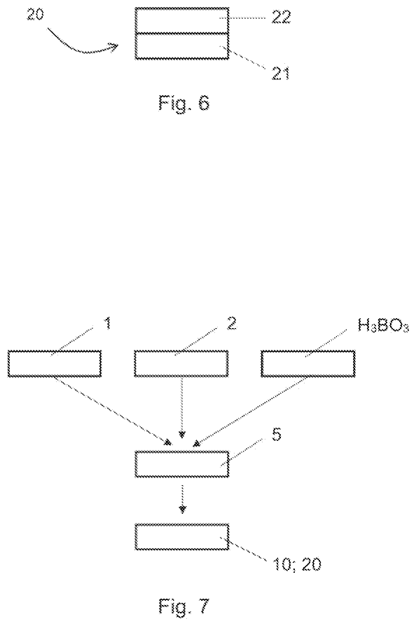

FIG. 6 schematic representation of a component of a solid-state battery cell,

FIG. 7: a schematic sequence of a method according to the invention,

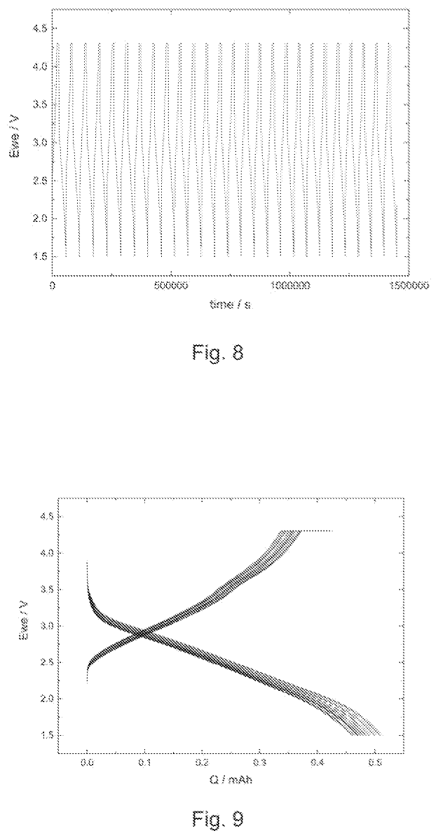

FIG. 8: charge cycles of a further battery cell over time, and

FIG. 9: Charge-discharge curves of the further battery cell.

### Experiment 1

Na_{3.4}Zr₂Si_{2.4}P_{0.6}O₁₂ (NZSiP3.4) was prepared according to the solution-assisted solid-state reaction described in the publication “Na₃Zr₂(SiO₄)₂(PO₄) prepared by a solution-assisted solid state reaction” by Naqash, S., et al, (Solid State Ionics, 2017. 302: p. 83-91) by dissolving stoichiometric amounts of sodium nitrate (NaNO₃), zirconium nitrate (ZrO(NO₃)₂), tetraethyl orthosilicate ((Si(OC₂H₆)₄) and ammonium dihydrogen phosphate (NH₄H₂PO₄) (molar ratio 3.4/2/2.4/0.6) in deionized water. The gel formed was thoroughly dried at 85° C., chopped to a fine powder and mixed well in an electric mortar. The resulting powder is a complete mixture of educts for producing NaSICON.

The powder was then calcined in air at 800° C. for 4 hours. The calcined powder was ball-milled in ethanol for 72 hours in a tumble mixer with ZrO₂ grinding balls (diameter 3 mm and 5 mm) to achieve a d50 particle size <3 μm or approx.3 μm. The ground powder was finally dried to obtain an intermediate product for producing NaSICON. The intermediate product for producing NaSICON corresponds to a calcined mixture of educts for producing NaSICON.

In experiment 1a, sodium hydroxide (NaOH) and orthoboric acid (H₃BO₃) were used as additives, in particular each in powder form. These were dissolved in deionized water in a molar ratio of 75% NaOH and 25% H₃BO₃, corresponding to 3 mol/mol. The intermediate product for producing NaSICON was added to the NaOH/H₃BO₃ solution while stirring. The mixing ratio was 0.71 g additive for 10 g intermediate product. The solvent (water) was evaporated with constant stirring on a magnetic stirrer heating plate to coat the intermediate product for producing NaSICON with the additives according to the invention. The dried powder was pulverized in an agate hand mortar and pressed into cylindrical pellets of 13 mm diameter at a pressure of 100 MPa. For comparison, the intermediate product without the additives was also pressed at 100 MPa to form pellets with a diameter of 13 mm. Alternatively, pellets can also be pressed at higher pressures, e.g., 200 MPa. Instead of pellets, any components for a solid-state battery can be produced in the same way. The pellets were then heated, namely sintered.

Table 1 shows the exact sintering parameters and the densities achieved (relative density as a proportion of the maximum achievable density) and ionic conductivities after sintering. The pressing force was applied uniaxially in each case. The measurement temperature refers to the ionic conductivity.

| | Sintering | Measurement | Ion conductivity | Relative |
|---|---|---|---|---|
| Pressing force | temperature in ° C. | temperature in ° C. | (σₜₒₜₐₗ) in mS/cm | density |
| Na_{3.4}Zr₂Si_{2.4}P_{0.6}O₁₂ | | | | |
| without additives | | | | |
| 15 kN (uni) | 1260 | 23 | 4.46 | 98% |
| with additives | | | | |
| 15 kN (uni) | 1050 | 23 | 3.66 | 93% |
| 15 kN (uni) | 1000 | 23.3 | 3.65 | 94% |
| 15 kN (uni) | 950 | 23.3 | 3.48 | 98% |
| 15 kN (uni) | 900 | 20 | 2.33 | 96% |
| 15 kN (uni) | 850 | 23.5 | 1.38 | 92% |
| 30 kN (uni) | 850 | 23.8 | 1.65 | 93% |

A maximum density is achieved at 950° C. with a very high ionic conductivity. Good densities and ionic conductivities are also achieved at lower temperatures. Overall, it can be seen that with the help of the additives according to the invention, it is possible to reduce the sintering temperature by several hundred degrees Celsius.

FIG. 1 shows an X-ray diffractogram of the various samples produced using conventional methods and methods according to the invention. The diffraction angle in 2θ is plotted on the x-axis and the intensity in arbitrary units is plotted on the y-axis. The intermediate products for the production of NaSICON were each produced using SA-SSR after calcination for 4 h. A stands for the intermediate product without the additives according to the invention and without further heating. B to H stand for the materials and/or components produced by further heating. Heating (sintering) was carried out for 6 h, respectively. B stands for sintering at 900° C. without the additives according to the invention (conventional method at reduced temperature). H stands for sintering at 1260° C. without the additives according to the invention (conventional method). C to G stand for the materials and/or components produced with the additives according to the invention. C stands for sintering at 850° C.; D stands for sintering at 900° C.; E stands for sintering at 950° C.; F stands for sintering at 1000° C.; G stands for sintering at 1050° C.

It can be seen that A has a completely different crystal structure. Less than 5% or less than 1% is included as NaSICON phase. B shows a poor result. The pure temperature reduction without additives does not lead to the desired NaSICON phase. Only approx. 20% is included as NaSICON phase; the influence of the secondary phase is strong. The peaks marked with a diamond (#) indicate a Na₂ZrSiO₇ phase. C to G are all comparable to H, i.e., the NaSICON phase produced by the conventional method. The peaks marked with an asterisk (*) indicate a ZrO₂-secondary phase. However, this can never be completely avoided and is not very present here. At least 99% is present as the desired NaSICON phase.

The reduced temperature during sintering of components is probably due at least in part to liquid-phase sintering, which occurs due to the additives used. Gaps are closed by a forming melt. In addition, reactive sintering can be assumed, which occurs in particular during the formation of the crystal structure when producing NaSICON.

In variations of the experiments, mixing ratios of 0.036 g/g and 0.142 g/g have achieved lower ionic conductivities. Consequently, mixing ratios between 0.036 g/g and 0.142 g/g are preferable. However, even in the case of unfavorable mixing ratios, the ionic conductivities achieved are still much better than without the additives according to the invention. The mixing ratios mentioned here and above show particularly good results when NaOH is used. With other sodium sources, slightly different mixing ratios can achieve optimum results.

In experiment 1b, H₃BO₃ was already added when producing the mixture of educts, especially in the form of the gel, for example using SA-SSR. In particular, it was added at the same time as sodium and/or zirconium nitrate. This means that the additive does not have to be subsequently mixed with the intermediate product to produce NaSICON.

Table 2 shows the sintering parameters analogous to Table 1 above. Reference is made to the explanations above. Unless otherwise stated, sintering was carried out for 6 h in each case. In one case, an isostatic pressure was applied in addition to the uniaxial force.

| | | | | |
|---|---|---|---|---|
| | Sintering | Measurement | Ion conductivity | Relative |
| Pressing force | temperature in ° C. | temperature in ° C. | (σₜₒₜₐₗ) in mS/cm | density |

Na_{3.4}Zr₂Si₂P_{0.8}B_{0.2}O₁₂

| | | | | |
|---|---|---|---|---|
| 15 kN uni | 1260 | 23 | 0.78 | 88% |
| 15 kN uni | 1150 | 25 | 2.68 | 92.5% |
| 15 kN uni | 1100 | 25 | 2.44 | 94% |
| 15 kN uni | 1050 | 23 | 1.94 | 96% |
| 15 kN uni + | 1050 | | 1.83 | 95% |
| 2000 bar iso | | | | |
| 15 kN uni | 1000 | 23.3 | 1.52 | 97.5% |
| 15 kN uni | 950 | 23.3 | 1.10 | 97% |
| 15 kN uni | 900 | 20 | 0.82 | 96% |
| 30 kN uni | 850 | 23.8 | 0.60 | 89% |

Due to the different manufacturing processes, the NaSICON compound formed may have a different composition. A general structural formula may be as follows: Na_{1+x+2y}Zr₂SiₓP_{3-x-y}B_{y}O₁₂, wherein an optimal window for y is between 0.1 and 0.4 and preferably between 0.2 and 0.3, corresponding to the boron concentration of the additive according to the invention. Here, the weighed-in figures are calculated as if boron were incorporated into the NaSICON structure. However, sintering can also result in a boron-containing secondary phase that forms at the grain boundary and is not incorporated into the crystal structure. In fact, the structural formula given is the molar element distribution in the entire material and not necessarily a chemical structural formula of the phase(s) present. Depending on the requirements, for example on the conductivity of the NaSICON compound, x may be between 1.4 and 2.2, preferably between 1.6 and 2.0. It can be seen that the correct NaSICON phase is formed even at low temperatures (850° C.), although the density and ionic conductivity do not completely match those achieved in experiment 1a.

### Experiment 2

The starting materials Na₂CO₃, ZrSiO₄, SiO₂, NH₄H₂PO₄ were weighed in a stoichiometric ratio and ground in ethanol in a planetary ball mill with ZrO₂ grinding balls. In this way, a mixture of educts for producing NaSICON was obtained. The additives according to the invention were added to the ground powder in a molar ratio of 3 moles of NaOH per mole of H₃BO₃. Per gram of the ground powder, 0.071 g of the mixture of additives was added. The powder obtained was pressed into pellets and sintered (900° C. or 1050° C.).

FIG. 2 shows an X-ray diffractogram of the various samples (see FIG. 1 above for the axes) produced by conventional methods and methods according to the invention. The educts for producing NaSICON were each produced using SSR. Heating (sintering) was performed for 6 hours in each case. A stands for the mixture of educts without the additives according to the invention and sintering at 1260° C. (conventional method). B stands for sintering at 1050° C. with the additives according to the invention. C stands for sintering at 900° C. with the additives according to the invention. As in FIG. 1, the peaks marked with an asterisk (*) indicate a ZrO₂ secondary phase.

It can be seen that the correct crystal structure of the NASICON phase can also be obtained here at a significantly lower sintering temperature with a single temperature treatment, as well as good densification and ionic conductivity. This is possible by means of solid-state reaction (SSR). Here, at least 90%, in particular at least 95% is present as the desired NaSICON phase. In addition, around 2-3% can be present as a ZrO₂ secondary phase.

FIG. 3 shows a simplified, schematic and not to scale representation of a solid-state battery cell 35. Since a solid-state battery 30 can also consist of a single solid-state battery cell 35, FIG. 3 also shows a solid-state battery 30. However, a solid-state battery 30 usually includes a plurality of solid-state battery cells 35, which are in particular connected in series or in parallel. These may be connected to each other via a current collector, for example in the form of a Cu film.

The solid-state battery cell 35 includes two electrodes 21, which are arranged on the two opposite sides of the separator 22. It is therefore a full cell. The separator 22 acts as a solid electrolyte and is ion-conductive, but not or only very slightly electron-conductive (electrically conductive).

The solid-state battery cell 35 may be symmetrical and comprise NNFM (Na_{0.67}[Fe_{0.1}Ni_{0.1}Mn_{0.8}]O₂) as the active material of the electrodes 21. The electrode 21 may be an anode or a cathode. These may have the same or different structures. For example, a Na metal anode may be present. The solid-state electrolyte or separator 22 consists in particular of NaSICON. The solid-state battery cell 35 was produced in particular according to experiment 3 and sintered in one step.

### Experiment 3

To produce a free-standing or single electrode 21, the active material NNFM was arranged together with educts for producing NaSICON and/or intermediate products for producing NaSICON together with the additives according to the invention and sintered together at 900° C.

FIG. 4 shows an X-ray diffractogram of the various samples (see FIG. 1 above for the axes) produced by conventional methods and methods according to the invention. A stands for crystalline active material NNFM. B stands for a mixture of educts for producing NaSICON with the additives according to the invention and sintering at 900° C. C stands for a mixture of educts for producing NaSICON with the additives according to the invention and NNFM and sintering at 900° C. D stands for the mixture of an intermediate product for producing NaSICON (in particular a calcined intermediate product according to SA-SSR, cf. experiment 1) with the additives according to the invention and NNFM and sintering at 900° C. Sintering, i.e. heating, was carried out for 6 hours in each case. The peaks marked with an asterisk * indicate a ZrO₂ secondary phase, as in FIG. 1.

It can be seen that the correct crystal structure of the NASICON phase and the NNFM phase can be obtained at the lower sintering temperature with a single temperature treatment, as well as good densification. This is possible, for example, by means of solid-state reaction (SSR). In this case, at least 90%, in particular at least 95%, are present in total as the desired NaSICON phase and NNFM phase.

### Experiment 4

For producing the electrodes 21, the active material NNFM was arranged together with educts for producing NaSICON or intermediate products for producing NaSICON together with the additives according to the invention. For producing the electrolyte and/or the separator 22, educts for producing NaSICON or intermediate products for producing NaSICON were arranged together with the additives according to the invention. In particular, the respective mixtures were arranged in the sequence shown in FIG. 3 and sintered together to obtain the solid-state battery cell 35 in a single sintering step.

FIG. 5 shows a diagram of the charging and discharging of a symmetrical battery cell produced by the method according to the invention. This is the battery cell from FIG. 3. The first charge 1^{st} L is marked. In the smaller diagram, the efficiency Eff is plotted against the cycle number ZN. It can be seen that the battery cell could be successfully charged and discharged several times with very good coulombic efficiency above 97%.

### Experiment 5

To produce an electrode 21, the active material NNFM was arranged together with educts for producing NaSICON or intermediate products for producing NaSICON together with the additives according to the invention. For producing the electrolyte and/or the separator 22, educts for producing NaSICON or intermediate products for producing NaSICON were arranged together with the additives according to the invention. The respective mixtures were arranged as shown in FIG. 6 and sintered together. In a further step, metallic sodium can be applied to the separator 22 as a further electrode 21, in particular as an anode, in order to obtain a solid-state battery cell.

FIG. 7 schematically shows a diagram of a method according to the invention. A starting material 1, a sodium source 2 and H₃BO₃ are mixed. The mixture is heated 5 together. This results in a material 10 for a solid-state battery and/or a component 20 for a solid-state battery.

FIGS. 8 and 9 show diagrams of the charging and discharging of a battery cell produced using the method according to the invention. This is the battery cell of FIG. 6, namely a full cell with a sodium anode, a separator made of NaSICON, which was produced using the additives according to the invention, and a mixed electrode (cathode) made of NNFM and NaSICON, which was produced using the additives according to the invention. The cathode and the separator were produced together in one step. FIG. 8 shows the charging cycles over time and FIG. 9 shows a representation analogous to FIG. 5. It can be seen that the battery cell could be successfully charged and discharged several times.

In one configuration, heating takes place over a period of at least 2 h, in particular at least 3 h and/or less than 6 h, in particular less than 5 h. Due to the additives according to the invention, longer heating is not necessary.

In one configuration, heating only takes place once. This can be the case in particular when producing a material including NaSICON using a starting material including educts for producing NaSICON or when producing a component for a solid-state battery using a starting material including NaSICON. Heating or sintering twice or more is not necessary due to the additives according to the invention.

In one embodiment, the starting material is such that it has a sodium content which corresponds stoichiometrically to the sodium included in the NaSICON to be produced. In other words, the starting material is such that it is stoichiometrically suitable for producing NaSICON, at least with respect to the sodium content. Since the sodium source is also added, more sodium is used overall than is stoichiometrically necessary for producing the NaSICON. In one embodiment, the sodium content in a mixture of the starting material and the sodium source for producing the NaSICON is over-stoichiometric.

In one embodiment, the ionic conductivity of the NaSICON-containing material or component produced is greater than 1 mS/cm at 25° C., in particular greater than 1.2 mS/cm and preferably greater than 1.5 mS/cm, more preferably greater than 1.8 mS/cm. In some exemplary embodiments, the ionic conductivity of the produced NaSICON-containing material or component is greater than 2 mS/cm, in particular greater than 2.5 mS/cm and preferably greater than 3 mS/cm. As described, a particularly high ionic conductivity can be achieved due to the additives according to the invention. In a particularly preferred configuration, the ionic conductivity is more than 0.5 mS/cm and less than 3 mS/cm.

In one embodiment, the heating is carried out in such a way that no melt is produced. This means that the starting material or the starting materials are not completely or even largely melted. This applies, for example, to the use of calcined educts for producing NaSICON, as described in experiment 1 above. In particular, heating is carried out to a temperature below the melting temperature of the starting material or starting materials used. The additives according to the invention are independent of this and may melt completely or partially.

In one embodiment, Na₂CO₃ and NH₄H₂PO₄ are used and/or reactive sintering takes place. This may result in partial and/or temporary melting of the starting materials and/or decomposition products of the starting materials.

In one embodiment, the material produced is largely crystalline. In particular, a proportion of at least 80%, preferably at least 90% and in particular at least 95% of the produced material has a NaSICON crystal structure.

In one embodiment, the NaSICON-containing phase of the produced component is largely crystalline. The component may comprise different materials. Typically, one of them is NaSICON or at least includes NaSICON. In this embodiment, this material is largely crystalline. In this embodiment, therefore, no glass phase or only an insignificant amount of glass phase is produced. In particular, a proportion of at least 80%, preferably at least 90% and in particular at least 95% of the NaSICON-including phase of the component has a NaSICON crystal structure.

In one embodiment, a mixing ratio of the sodium source and H₃BO₃ is greater than 1 mol Na/mol H₃BO₃, in particular greater than 2 mol Na/mol H₃BO₃ and/or less than 6 mol Na/mol H₃BO₃, in particular less than 4 mol Na/mol H₃BO₃. Preferably, the mixing ratio is approx. 3 mol Na/mol H₃BO₃. This superstoichiometric sodium dosage has proven to be optimal for achieving a high ionic conductivity and a high relative density.

### LIST OF REFERENCE SIGNS

Starting material 1
Sodium source 2
Heating 5
Material 10
Component 20
Electrode 21
Separator 22
Solid-state battery 30
Solid-state battery cell 35
First charge 1^{st} L
Efficiency Eff
Cycle No. ZN
time time

1. Method for producing a material for a solid-state battery and/or a component for a solid-state battery, the material or the component comprising NaSICON, in which at least one starting material together with a sodium source and H₃BO₃ is heated to a temperature between 600° C. and 1300° C., wherein heating takes place only once, wherein the starting material comprises at least one of
educts for producing NaSICON,
at least one intermediate product for producing NaSICON
a mixture of at least one educt for producing NaSICON and at least one intermediate product for producing NaSICON, and
NaSICON,
wherein the starting material is such that it has a sodium content which corresponds stoichiometrically to the sodium included in the NaSICON to be produced.

2. The method of claim 1, wherein temperature is below 1100° C.

3. The method of claim 1, wherein NaOH is used as the sodium source.

4. The method of claim 1, wherein a material containing NaSICON is produced for a solid-state battery, wherein the starting material includes educts for producing NaSICON.

5. The method of claim 1, wherein a component for a solid-state battery is produced, wherein the starting material includes at least one educt for producing NaSICON.

6. The method of claim 1, wherein a component for a solid-state battery is produced, wherein the starting material includes at least one intermediate product for producing NaSICON.

7. The method of claim 1, wherein a component for a solid-state battery is produced, wherein the starting material includes NaSICON.

8. The method of claim 1, wherein the at least one starting material is present in powder form, is mixed with the sodium source and the H₃BO₃, is pressed into shape and is then heated.

9. The method of claim 1, wherein an electrode or a separator is produced as the component.

10. The method of claim 1, wherein the component comprises an electrode and a separator, wherein the electrode and the separator are heated together and are in this way produced together in one step.

11. The method of claim 1, wherein a component for a solid-state battery is produced, wherein the component is a solid-state battery cell consisting of a separator and two electrodes.

12. The method of claim 11, wherein the solid-state battery cell is a symmetrical solid-state battery cell with two electrodes of the same type.

13. The method of claim 1, wherein the heating is carried out in an oxygen-containing atmosphere.

14. Solid-state battery cell produced according to the method of claim 1, the solid-state battery cell comprising
a separator and
two electrodes.

15. The solid-state battery cell of claim 14, wherein at least one of the two electrodes comprises NNFM and NaSICON.

16. The solid-state mattery cell of claim 14, wherein one of the two electrodes is produced from sodium.

17. The solid-state battery cell of claim 15, wherein one of the two electrodes is produced from sodium.

18. The solid-state battery cell of claim 15, wherein the separator comprises NaSICON.

19. The method of claim 2, wherein the temperature is below 1000° C.

20. The method of claim 19, wherein the temperature is below 900° C.
